(19) United States
(12) Patent Application Publication
(10) Pub. No.: US 2026/0004971 A1
(43) Pub. Date: Jan. 1, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Sumin Shin, Suwon-si (KR); Wonmi Choi, Suwon-si (KR); Jihye Ahn, Suwon-si (KR)

(73) Assignee: SAMSUNG ELECTRO-MECHANICS CO., LTD., Suwon-si (KR)

(21) Appl. No.: 18/953,800

(22) Filed: Nov. 20, 2024

(30) Foreign Application Priority Data
Jun. 28, 2024 (KR) 10-2024-0085227

(51) Int. Cl. H01G 4/008; H01G 4/12; H01G 4/30; H01G 4/33

(52) U.S. Cl. CPC H01G 4/008; H01G 4/12; H01G 4/30; H01G 4/33

(57) ABSTRACT

A multilayer ceramic capacitor and a method of manufacturing the same, the multilayer ceramic capacitor including a capacitor body including a dielectric layer and an internal electrode layer, and an external electrode disposed on the outside of the capacitor body, wherein the internal electrode layer includes a metal layer including nickel (Ni); and a surface layer disposed on the surface of the metal layer and including bismuth (Bi), and the bismuth (Bi) is included in the surface layer in an amount of about 0.01 to about 5.3 parts by atom based on 100 parts by atom of nickel (Ni) present in the entire internal electrode layer.

### CROSS-REFERENCE TO RELATED APPLICATION

This application claims priority to and the benefit of Korean Patent Application No. 10-2024-0085227 filed in the Korean Intellectual Property Office on Jun. 28, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, there has been a strong demand for downsizing and large capacitance multilayer ceramic capacitors. Accordingly, thinning and multi-layering of the dielectric layer and internal electrode layer are being attempted in various ways, and products are being manufactured in which the thickness of the dielectric layer is reduced while the number of layers increases. However, the thin film formation of this dielectric layer increases the electric field intensity per unit area, which causes the reliability of the multilayer ceramic capacitor to deteriorate.

### SUMMARY

An embodiment provides a multilayer ceramic capacitor having excellent high-temperature reliability.

Another embodiment provides a method of manufacturing a multilayer ceramic capacitor.

An embodiment provides a multilayer ceramic capacitor including a capacitor body including a dielectric layer and an internal electrode layer, and an external electrode disposed on an outer surface of the capacitor body, wherein the internal electrode layer includes a metal layer including nickel (Ni); and a surface layer disposed on a surface of the metal layer and including bismuth (Bi), and bismuth (Bi) is included in the surface layer in an amount of about 0.01 to about 5.3 parts by atom based on 100 parts by atom of nickel (Ni) present in the entire internal electrode layer.

Bismuth (Bi) may be included in the surface layer in an amount of 0.05 parts by atom to 5.0 parts by atom based on 100 parts by atom of nickel (Ni) present in the entire internal electrode layer.

The surface layer may be disposed at an interface between the metal layer and the dielectric layer on the surface of the metal layer.

The interface may be disposed on an upper surface of the metal layer, a lower surface of the metal layer, and a side surface of the metal layer in the thickness direction of the multilayer ceramic capacitor, and the surface layer may be disposed on at least one of the upper surface of the metal layer, the lower surface of the metal layer, and the side surface of the metal layer.

The surface layer may be disposed between an end of the metal layer electrically connected to the external electrode and one side of the external electrode.

The surface layer may surround an entire surface of the metal layer.

When analyzing a TEM-EDS (Transmission Electron Microscopy-Energy Dispersive Spectroscopy) line for a straight section from one point in the internal electrode layer to one point in the dielectric layer adjacent to the internal electrode layer, the metal layer may be a region having a maximum atomic % value of nickel (Ni), and the surface layer may be a region having a maximum atomic % value of bismuth (Bi).

The surface layer may further include bismuth oxide (Bi₂O₃).

The surface layer may further include nickel (Ni).

Bismuth (Bi) may be included in the surface layer in an amount of greater than or equal to about 50 atomic % based on a total amount of bismuth (Bi) and nickel (Ni) present in the surface layer.

Bismuth (Bi) may be included in the surface layer in an amount of about 50 atomic % to about 75 atomic % based on a total amount of bismuth (Bi) and nickel (Ni) present in the surface layer.

The surface layer may further include one or more selected from titanium (Ti), barium (Ba), and oxygen (O).

The surface layer may have an average thickness of about 1 nm to about 50 nm.

The surface layer may surround an entirety of the metal layer.

The surface layer may further include titanium (Ti), barium (Ba), and oxygen (O).

Another embodiment provides a method of manufacturing a multilayer ceramic capacitor which includes mixing nickel (Ni) and a bismuth (Bi) based raw material to prepare a conductive paste; manufacturing a dielectric green sheet from a dielectric slurry and printing the conductive paste on a surface of the dielectric green sheet to form a conductive paste layer; manufacturing a dielectric green sheet stack by stacking a plurality of the dielectric green sheets on which the conductive paste layer is formed; manufacturing a capacitor body comprising a dielectric layer and an internal electrode layer by firing the dielectric green sheet stack; and forming an external electrode on an outer surface of the capacitor body, wherein the internal electrode layer includes a metal layer including nickel (Ni); and a surface layer disposed on a surface of the metal layer and including bismuth (Bi), and the bismuth (Bi)-based raw material is mixed in an amount such the bismuth (Bi) is present in about 0.01 parts by atom to about 5.3 parts by atom based on 100 parts by atom of nickel (Ni) present in the entire internal electrode layer.

The bismuth (Bi)-based raw material may include at least one selected from bismuth (Bi) and bismuth oxide (Bi₂O₃).

The bismuth (Bi)-based raw material may include bismuth oxide (Bi₂O₃). A multilayer ceramic capacitor according to an embodiment can improve high-temperature reliability by including an internal electrode layer capable of suppressing oxidation of nickel (Ni).

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 shows the Ellingham diagram of nickel (Ni) and bismuth (Bi).

FIG. 6 is a TEM-EDS (transmission electron microscope-energy dispersive spectroscopy) line analysis diagram for a straight section from the internal electrode layer to the dielectric layer according to Example 1.

FIG. 7A is a TEM-EDS (transmission electron microscope-energy dispersive spectroscopy) mapping analysis diagram for the metal layer of the internal electrode layer according to Example 1.

FIG. 7B is a TEM-EDS (transmission electron microscope-energy dispersive spectroscopy) mapping analysis diagram of the surface layer of the internal electrode layer according to Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be disposed above or below the reference element, and it is not necessarily referred to as being disposed “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

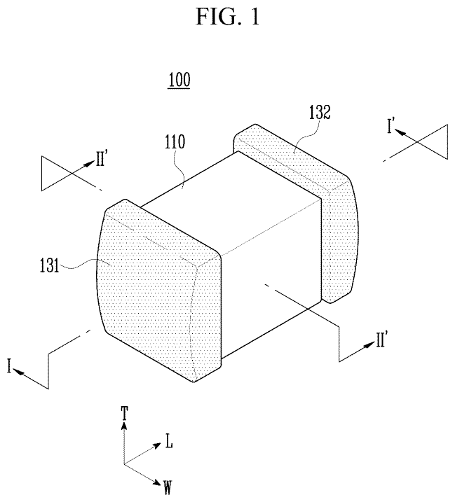

Hereinafter, a multilayer ceramic capacitor according to an embodiment will be described with reference to FIGS. 1 to 4.

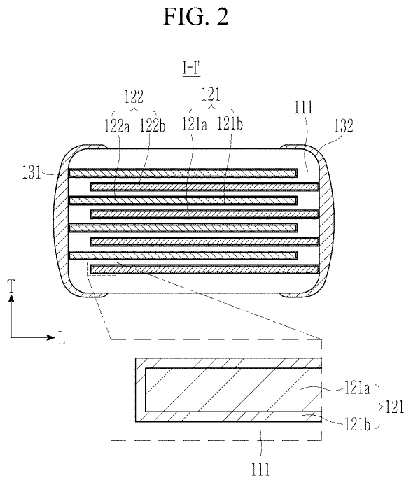

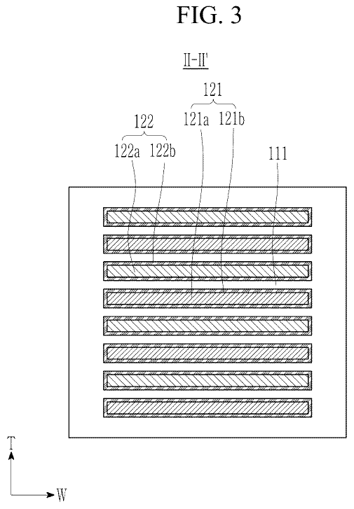

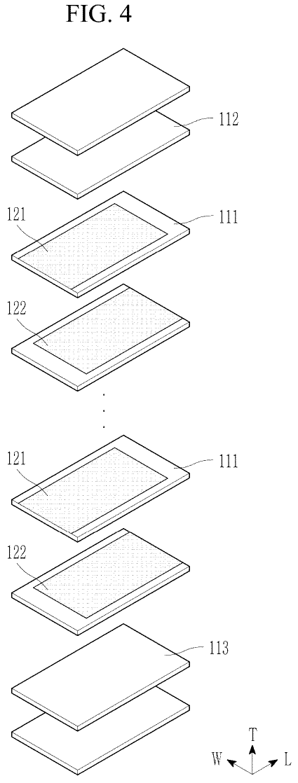

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be disposed on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin area serve to prevent damage to the first internal electrode layer 121 and the second internal electrode layer 122 due to physical or chemical stress.

Hereinafter, each of the internal electrode layer, dielectric layer, and external electrode is described in detail.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

Referring to FIG. 2, the internal electrode layer 121 and 122 according to an embodiment includes metal layers 121a and 122a and surface layers 121b and 122b on the surface of the metal layers 121a and 122a. Specifically, the first internal electrode layer 121 includes a first metal layer 121a and a first surface layer 121b disposed on the surface of the first metal layer 121a, and the second internal electrode layer 122 includes a second metal layer 122a and a second surface layer 122b on the surface of the second metal layer 122a.

The metal layers 121a and 122a includes nickel (Ni), and the surface layers 121b and 122b) includes bismuth (Bi).

A typical manufacturing method of a multilayer ceramic capacitor includes printing a conductive paste on a dielectric green sheet to form a conductive paste layer, and stacking dielectric green sheets on which a conductive paste layer is formed to form a dielectric green sheet stack. The dielectric green sheet stack is formed into a multilayer ceramic capacitor consisting of an internal electrode layer and a dielectric layer through a calcination and firing process. However, the firing process causes oxidation of nickel (Ni), the material of the internal electrode layer, to form nickel oxide (NiO). When nickel (Ni) is oxidized, the electrical conductivity of the internal electrode layer decreases, and the concentration of oxygen vacancies in the dielectric increases through a chemical reaction between the BaTiO₃ dielectric and nickel oxide (NiO). Ultimately, oxidation of nickel (Ni) in the internal electrode layers causes a decrease in the high-temperature reliability of multilayer ceramic capacitors.

A multilayer ceramic capacitor according to an embodiment of the present disclosure includes an internal electrode layer having a surface layer including bismuth (Bi) on the surface of a metal layer including nickel (Ni), thereby suppressing oxidation of nickel (Ni) in the internal electrode layer. Accordingly, the high-temperature reliability of the multilayer ceramic capacitor can be improved.

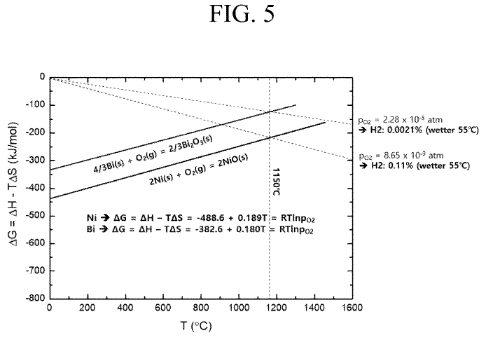

FIG. 5 shows the Ellingham diagram of nickel (Ni) and bismuth (Bi).

Referring to FIG. 5, it can be expected that bismuth (Bi) has a relatively lower oxidation tendency than nickel (Ni). Accordingly, when a surface layer of bismuth (Bi) material is formed on the surface of a metal layer of nickel (Ni) material, oxidation of nickel can be suppressed, and an internal electrode layer of this structure can improve the high-temperature reliability of a multilayer ceramic capacitor.

The bismuth (Bi) included in the surface layers 121b and 122b may be included in an amount of about 0.01 parts by atom to about 5.3 parts by atom, for example about 0.03 parts by atom to about 5.2 parts by atom, or about 0.05 parts by atom to about 5.0 parts by atom based on 100 parts by atom of nickel (Ni) included in the entire internal electrode layers 121 and 122. When bismuth (Bi) is included in the surface layer within the above content range, oxidation of nickel in the internal electrode layer is suppressed, thereby securing a multilayer ceramic capacitor with excellent high-temperature reliability.

Referring to FIG. 2, the internal electrode layers 121 and 122 according to an embodiment has a structure in which surface layers 121b and 122b including bismuth (Bi) is disposed on the surface of a metal layers 121a and 122a including nickel (Ni).

Specifically, the surface layers 121b and 122b may be disposed on the surface of the metal layers 121a and 122a and may be disposed at the interface between the metal layers 121a and 122a and the dielectric layer 111. The interface between the metal layers 121a and 122a and the dielectric layer 111 may have the upper surface, the lower surface, and the side surface of the metal layers 121a and 122a in the thickness direction (T-axis direction) of the multilayer ceramic capacitor. For example, the surface layers 121b and 122b may be interfaces between the metal layers 121a and 122a and the dielectric layer 111, and may be disposed on at least one of the upper surface, the lower surface, and the side surface of one metal layers 121a and 122a, and for example, may be disposed on all of the upper surface, lower surface, and side surface of one metal layers 121a and 122a.

Additionally, the surface layers 121b and 122b may be additionally disposed between an end of the metal layers 121a and 122a that is electrically connected to the external electrodes 131 and 132 and one surface of the external electrodes 131 and 132 while being disposed on the surface of the metal layers 121a and 122a. That is, the surface layers 121b and 122b is not only disposed at the interface between the metal layers 121a and 122a and the dielectric layer 111, but can also be disposed between the end portion electrically connected to the external electrodes 131 and 132 and one surface of the external electrode among the side surfaces of the metal layers 121a and 122a in the thickness direction (T-axis direction) of the multilayer ceramic capacitor.

For example, the surface layers 121b and 122b may have a structure that surrounds the entire surface of the metal layers 121a and 122a. FIG. 2 illustrates a structure in which the surface layers 121b and 122b surround the entire surface of the metal layers 121a and 122a, but this is only an example of a structure for convenience and is not limited thereto.

The structure of the metal layers 121a and 122a and the surface layers 121b and 122b of the internal electrode layers 121 and 122 and the components forming the metal layer and the surface layer can be confirmed through TEM-EDS (transmission electron microscope-energy dispersive spectroscopy) line analysis. Additionally, the composition of the metal layers 121a and 122a and the surface layers 121b and 122b can be confirmed through TEM-EDS (transmission electron microscope-energy dispersive spectroscopy) mapping analysis. Other methods and/or tools appreciated by one of ordinary skill in the art, even if not described in the present disclosure, may also be used.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a transmission electron microscope (TEM) so that at least one layer, for example, one to five layers of the dielectric layer and the internal electrode layer was visible. For example, TEM can be measured under conditions of an acceleration voltage of 200 kV using a Xe-FIB (focused ion beam) in an area of about 400 nm×400 nm in which at least one dielectric layer and one internal electrode layer were visible in the active region.

Next, in the TEM image of the measured cross-sectional sample, EDS (energy dispersive spectroscopy) line analysis can be performed on a straight line section from a point in any internal electrode layer to a point in the dielectric layer adjacent to the internal electrode layer. Through EDS line analysis, the structure of the metal layers 121a and 122a and the surface layers 121b and 122b of the internal electrode layer and the components present in the metal layer and the surface layer can be confirmed.

According to this TEM-EDS line analysis, the metal layers 121a and 122a according to an embodiment may be a region where the atomic % of nickel (Ni) has the maximum value, and the surface layers 121b and 122b may be a region where the atomic % of bismuth (Bi) has the maximum value.

The metal layers 121a and 122a may include nickel (Ni), and may include a conductive metal other than nickel (Ni). Examples of the above conductive metals include one or more selected from copper (Cu), silver (Ag), palladium (Pd), gold (Au), and an alloy thereof, such as an Ag—Pd alloy.

The surface layers 121b and 122b may include bismuth (Bi) and may further include bismuth oxide (Bi₂O₃). The bismuth (Bi) of the surface layers 121b and 122b can be derived from a bismuth (Bi)-based raw material used as a component of a conductive paste when forming an internal electrode layer. That is, in the process of manufacturing a dielectric green sheet stack using a conductive paste including a bismuth (Bi)-based raw material and then firing it, the bismuth (Bi)-based raw material is pushed outward relative to nickel (Ni) to form surface layers 121b and 122b of the internal electrode layers 121 and 122.

Additionally, the surface layers 121b and 122b may further include nickel (Ni). The nickel (Ni) of the surface layers 121b and 122b may be nickel (Ni) used when forming the internal electrode layer.

The bismuth (Bi) included in the surface layers 121b and 122b may be included in an amount of greater than or equal to about 50 atomic %, for example about 50 atomic % to about 100 atomic %, or about 50 atomic % to about 75 atomic % based on the total amount of bismuth (Bi) and nickel (Ni) included in the surface layers 121b and 122b. When bismuth (Bi) is included in the surface layer within the above content range, oxidation of nickel in the internal electrode layer is suppressed, thereby securing a multilayer ceramic capacitor with excellent high-temperature reliability.

Additionally, the surface layers 121b and 122b may further include one or more selected from titanium (Ti), barium (Ba), and oxygen (O). These components may be derived from a barium titanate-based compound used as a main component of a dielectric slurry when forming a dielectric layer, or may be derived from barium titanate powder as a co-material that may be added to a conductive paste for forming an internal electrode layer as needed.

The average thickness of the surface layers 121b and 122b, i.e., the first surface layer 121b and the second surface layer 122b, may be about 1 nm to about 50 nm, for example, about 5 nm to about 45 nm. When the average thickness of the surface layer is within the above range, oxidation of nickel in the internal electrode layer can be suppressed, and thus the high-temperature reliability of the multilayer ceramic capacitor can be improved.

The thickness of the surface layer can be confirmed by SEM (scanning electron microscope) analysis. In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a scanning electron microscope (SEM) so that at least one layer, for example, one to five layers of the dielectric layer and the internal electrode layer are visible. For example, SEM can be measured under conditions of 10 kV in an area of about 400 nm×400 nm, where at least one dielectric layer and one internal electrode layer are visible in the active region, using a Verios G4 product from Thermofisher Scientific. Other methods and/or tools appreciated by one of ordinary skill in the art, even if not described in the present disclosure, may also be used.

This can be obtained by taking the central point of the length direction (L-axis direction) or width direction (W-axis direction) of the first surface layer 121b and the second surface layer 122b as a reference point in a scanning electron microscope (SEM) image of a cross-sectional sample measured as described above, and taking the arithmetic mean value of the thickness of the first surface layer 121b and the second surface layer 122b at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the first surface layer 121b and second surface layer 122b, and if all 10 points are not positioned within the first surface layer 121b and second surface layer 122b, the position of the reference point may be changed, or the interval between the 10 points may be adjusted.

The average thickness of the first internal electrode layer 121 and the second internal electrode layer 122 may be about 0.1 μm to about 2 μm. When the average thickness of the first internal electrode layer 121 and the second internal electrode layer 122 is within the above range, the reliability of the multilayer ceramic capacitor is excellent.

This can be obtained by taking the central point in the longitudinal direction (L-axis direction) or the width direction (W-axis direction) of the first internal electrode layer 121 or the second internal electrode layer 122 as a reference point in a scanning electron microscope (SEM) image of a cross-sectional sample measured as described above, and taking the arithmetic mean value of the thickness of the first internal electrode layer 121 or the second internal electrode layer 122 at 10 points spaced apart from the reference point by a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be located within the first internal electrode layer 121 or the second internal electrode layer 122, and if all 10 points are not located within the first internal electrode layer 121 or the second internal electrode layer 122, the location of the reference point can be changed or the spacing between the 10 points can be adjusted.

### Dielectric Layer

According to an embodiment, the dielectric layer 111 may include a barium titanate-based compound including barium (Ba) and titanium (Ti) as a main component.

The barium titanate-based compound is a dielectric base material, has a high dielectric constant, and contributes to forming the dielectric constant of the multilayer ceramic capacitor 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The dielectric layer 111 may further include a subcomponent. The subcomponent may include, for example, at least one selected from manganese (Mn), chromium (Cr), silicon (Si), aluminum (AI), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor is excellent.

This can be obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be disposed within the dielectric layer 111, and if all 10 points are not disposed within the dielectric layer 111, the position of the reference point may be changed, or the interval between the 10 points may be adjusted.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include at least one selected from copper (Cu), nickel (Ni), silver (Ag), palladium (Pd), gold (Au), platinum (Pt), tin (Sn), tungsten (W), titanium (Ti), lead (Pb), an alloy thereof, and a combination thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr), and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio (major axis/minor axis) of the major axis and the minor axis is less than or equal to about 1.45. Flake shape powder refers to a powder with a flat and elongated shape, and is not particularly limited. But for example, the length ratio (major axis/minor axis) of the major axis and the minor axis may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to an embodiment will be described.

A multilayer ceramic capacitor 100 according to an embodiment includes mixing nickel (Ni) and a bismuth (Bi)-based raw material to prepare a conductive paste; manufacturing a dielectric green sheet using a dielectric slurry and printing the conductive paste on the surface of the dielectric green sheet to form a conductive paste layer; manufacturing a dielectric green sheet stack by stacking the dielectric green sheet in which the conductive paste layer is formed; manufacturing a capacitor body including a dielectric layer and an internal electrode layer by firing the dielectric green sheet stack; and forming an external electrode on the outside of the capacitor body.

In the step of preparing the conductive paste, the bismuth (Bi)-based raw material may include at least one selected from bismuth (Bi) and bismuth oxide (Bi₂O₃).

The conductive paste may be prepared by mixing nickel (Ni) and bismuth (Bi)-based raw material. The bismuth (Bi)-based raw material may be mixed in an amount such that the bismuth (Bi) may be about 0.01 parts by atom to about 5.3 parts by atom based on 100 parts by atom of nickel (Ni) present in the entire internal electrode layer

For example, the bismuth (Bi)-based raw material may be mixed in an amount such that bismuth (Bi) may be about 0.03 parts by atom to about 5.2 parts by atom, or about 0.05 parts by atom to about 5.0 parts by atom based on 100 parts by atom of nickel (Ni) present in the entire internal electrode layer. When a bismuth (Bi)-based raw material is mixed within the above content range, an internal electrode layer in which nickel oxidation is suppressed can be formed, and thus a multilayer ceramic capacitor with excellent high-temperature reliability can be manufactured.

In addition to nickel (Ni), the conductive paste may be prepared by further mixing one or more conductive metals selected from copper (Cu), silver (Ag), palladium (Pd), gold (Au) and an alloy thereof, such as an Ag—Pd alloy.

Additionally, the conductive paste may be prepared by additionally mixing a conductive powder, a binder, and a solvent. Additionally, barium titanate powder may be mixed in as a co-material if necessary. The co-material may act to suppress sintering of the conductive powder during the firing process.

In the manufacturing of the dielectric green sheet, a dielectric slurry may be prepared by mixing a barium titanate-based compound as a main component powder and optionally a subcomponent powder. The subcomponent powder may be an oxide or salt compound, or may be used in the form of a sol dispersed in an organic solvent.

Additionally, the dielectric slurry may be prepared by additionally mixing additives such as a dispersant, a binder, a plasticizer, a lubricant, an antistatic agent, and a solvent.

The dispersant may include at least one selected from, for example, a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduce.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

The conductive paste layer is formed by applying a conductive paste to the surface of the dielectric green sheet in a predetermined pattern using various printing methods such as screen printing or transfer methods.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode. For example, firing may be performed at a temperature of about 1100° C. to about 1400° C., and may be performed at a temperature of about 1200° C. to about 1350° C. Additionally, firing may be performed for about 0.5 to about 8 hours, for example, about 1 to about 3 hours. Additionally, firing may be performed in a reducing atmosphere, for example, in a humidified mixed gas of nitrogen and hydrogen. When the internal electrode includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### Manufacturing of Multilayer Ceramic Capacitors

### Example 1

Nickel (Ni) and bismuth oxide (Bi₂O₃) were mixed to prepare a conductive paste. Herein, Bi₂O₃ was mixed in a content of 0.05 parts by atom of Bi based on 100 parts by atom of Ni in a finally formed internal electrode layer.

Subsequently, a dielectric slurry was prepared by using barium titanate (BaTiO₃) powder. Herein, the dielectric slurry was prepared by mechanical milling after adding ethanol/toluene, a dispersant, and a binder with zirconia (ZrO₂) balls as a dispersion medium together in addition to the barium titanate (BaTiO₃) powder.

Subsequently, the dielectric slurry was used by using a head discharge type on-roll forming coater to manufacture a dielectric green sheet. On the surface of the dielectric green sheet, the conductive paste was printed to form a conductive paste layer.

More than one of the dielectric green sheet with the conductive paste layer formed thereon were stacked and pressed to manufacture a dielectric green sheet stack.

The dielectric green sheet stack was fired under the conditions of a firing temperature of 1300° C. or lower and a hydrogen concentration of 1.0% H₂ or lower through a calcination process under a nitrogen atmosphere at 400° C. or lower.

Subsequently, the dielectric green sheet stack was used to manufacture a multilayer ceramic capacitor through processes of an external electrode, plating, or the like.

### Example 2

A multilayer ceramic capacitor was manufactured in the same manner as in Example 1 except that Bi₂O₃ was mixed in a Bi content of 0.1 parts by atom based on 100 parts by atom of Ni in the entire internal electrode layer of Example 1.

### Example 3

A multilayer ceramic capacitor was manufactured in the same manner as in Example 1 except that Bi₂O₃ was mixed in a Bi content of 0.5 parts by atom based on 100 parts by atom of Ni in the entire internal electrode layer of Example 1.

### Example 4

A multilayer ceramic capacitor was manufactured in the same manner as in Example 1 except that Bi₂O₃ was mixed in a Bi content of 1.0 parts by atom based on 100 parts by atom of Ni in the entire internal electrode layer of Example 1.

### Example 5

A multilayer ceramic capacitor was manufactured in the same manner as in Example 1 except that Bi₂O₃ was mixed in a Bi content of 2.5 parts by atom based on 100 parts by atom of Ni in the entire internal electrode layer of Example 1.

### Example 6

A multilayer ceramic capacitor was manufactured in the same manner as in Example 1 except that Bi₂O₃ was mixed in a Bi content of 4.0 parts by atom based on 100 parts by atom of Ni in the entire internal electrode layer of Example 1.

### Example 7

A multilayer ceramic capacitor was manufactured in the same manner as in Example 1 except that Bi₂O₃ was mixed in a Bi content of 5.0 parts by atom based on 100 parts by atom of Ni in the entire internal electrode layer of Example 1.

### Comparative Example 1

A multilayer ceramic capacitor was manufactured in the same manner as in Example 1 except that Bi₂O₃ was not used to prepare the conductive paste in Example 1.

### Comparative Example 2

A multilayer ceramic capacitor was manufactured in the same manner as in Example 1 except that Bi₂O₃ was mixed in a Bi content of 5.5 parts by atom based on 100 parts by atom of Ni in the entire internal electrode layer of Example 1.

### Comparative Example 3

A multilayer ceramic capacitor was manufactured in the same manner as in Example 1 except that Bi₂O₃ was mixed in a Bi content of 6.0 parts by atom based on 100 parts by atom of Ni in the entire internal electrode layer of Example 1.

### Evaluation 1: TEM-EDS Line Analysis

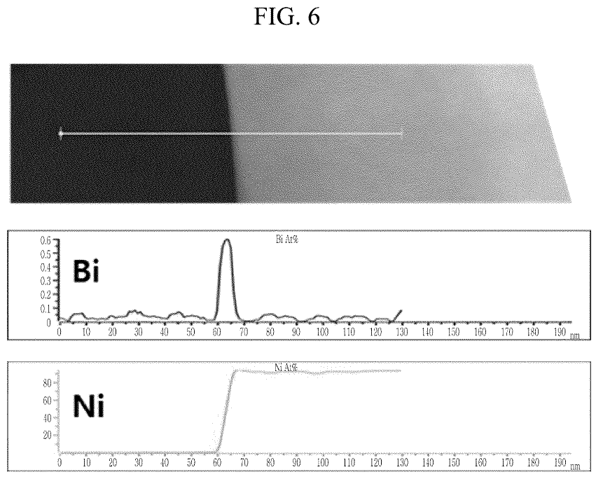

The multilayer ceramic capacitor of Example 1 was subjected to TEM-EDS (transmission electron microscope-energy dispersive spectroscopy) line analysis, and the result is shown in FIG. 6.

Specifically, the cross-sectional sample was obtained such that the active region where the dielectric layer and the internal electrode layer intersect may be observed, as the multilayer ceramic capacitor manufactured in Example 1 was placed into an epoxy mixture liquid and cured, the W-axis and T-axis direction surface (WT surface) of the capacitor body was polished to a depth of ½ in the L-axis direction, and then it was fixed and maintained in a vacuum atmosphere chamber. Next, the active region of the cross-sectional sample can be measured using a scanning electron microscope (SEM) so that at least one layer of the dielectric layer and the internal electrode layer is visible. TEM was measured under conditions of an acceleration voltage of 200 kV using an Xe-FIB (focused ion beam) in an area of about 400 nm×400 nm in which at least one dielectric layer and one internal electrode layer are visible in the active region. Next, in the TEM image of the measured cross-sectional sample, EDS (energy dispersive spectroscopy) line analysis was performed on a straight line section from a point in any internal electrode layer to a point in the dielectric layer adjacent to the internal electrode layer.

FIG. 6 is a TEM-EDS (transmission electron microscope-energy dispersive spectroscopy) line analysis diagram for a straight section from the internal electrode layer to the dielectric layer according to Example 1.

Referring to FIG. 6, in the TEM-EDS (transmission electron microscope-energy dispersive spectroscopy) line analysis, a region having maximum nickel (Ni) atomic % corresponds to a metal layer of the internal electrode layer, and another region having maximum bismuth (Bi) atomic % corresponds to a surface layer on the interface between the metal layer and the dielectric layer.

Accordingly, the internal electrode layer according to an embodiment turned out to include the metal layer including nickel (Ni) and the surface layer including bismuth (Bi) on the surface of the metal layer.

### Evaluation 2: TEM-EDS Mapping Analysis

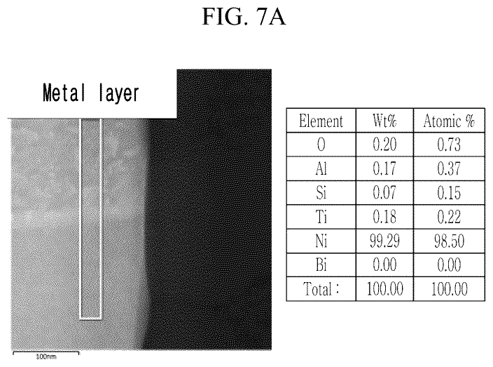

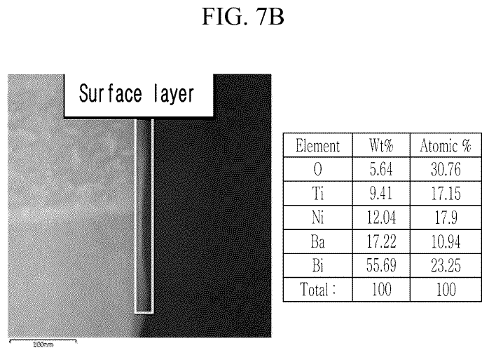

The multilayer ceramic capacitors according to Examples 1 to 7 and Comparative Examples 1 to 3 were subjected to TEM-EDS (transmission electron microscope-energy dispersive spectroscopy) mapping analysis, and the results are shown in FIGS. 7A and 7B.

In the TEM image of the cross-sectional sample of Evaluation 1, one region inside the internal electrode layer and one interfacial region between the internal electrode layer and the dielectric layer were subjected to EDS (energy distribution spectroscopy) mapping analysis to check components and their contents in the former, which is the metal layer of the internal electrode layer, and the latter, which is the surface layer of the internal electrode layer.

FIG. 7A is a TEM-EDS (transmission electron microscope-energy dispersive spectroscopy) mapping analysis diagram for the metal layer of the internal electrode layer according to Example 1, and FIG. 7B is a TEM-EDS (transmission electron microscope-energy dispersive spectroscopy) mapping analysis diagram of the surface layer of the internal electrode layer according to Example 1.

Referring to FIG. 7A, the metal layer of the internal electrode layer of Example 1 was made of nickel (Ni) but no bismuth (Bi). In addition, referring to FIG. 7B, in the surface layer of the internal electrode layer according to Example 1, bismuth (Bi) was present. Accordingly, when the internal electrode layer was formed by using the conductive paste according to an embodiment, the bismuth (Bi)-based raw material, compared with nickel (Ni), was pushed outward in the firing process to form the surface layer of the internal electrode layer.

In addition, in the multilayer ceramic capacitors according to Examples 1 to 7 and Comparative Examples 1 to 3, Ni and Bi contents in each internal electrode layer are shown in Table 1. Herein, the Bi content is shown based on 100 parts by atom of Ni in the entire internal electrode layer.

TABLE 1

| | Ni content of the entire | Bi content of |
|---|---|---|
| | internal electrode layer | surface layer |
| | (parts by atom) | (parts by atom) |
| Example 1 | 100 | 0.05 |
| Example 2 | 100 | 0.1 |
| Example 3 | 100 | 0.5 |
| Example 4 | 100 | 1.0 |
| Example 5 | 100 | 2.5 |
| Example 6 | 100 | 4.0 |
| Example 7 | 100 | 5.0 |
| Comparative Example 1 | 100 | 0 |
| Comparative Example 2 | 100 | 5.5 |
| Comparative Example 3 | 100 | 6.0 |

### Evaluation 3: High-Temperature Reliability

The multilayer ceramic capacitors according to Examples 1 to 7 and Comparative Examples 1 to 3 were measured with respect to capacitance and accelerated life-span reliability (MTTF), and the results are shown in Table 2.

The capacitance was measured as capacity (F) under the conditions of a frequency of 1 kHz and a voltage of 0.5 V.

MTTF (mean time to failure) was measured by calculating average failure time (hr) under the conditions of a temperature of 125° C., a voltage of 9.45 V, and 48 hours.

Referring to Table 2, the Bi content of the surface layer was expressed based on 100 parts by atom of the Ni content of the entire internal electrode layer, and the capacitance and MTTF correspond to each ratio based on the results of Comparative Example 1.

TABLE 2

| | Bi content of | | |
|---|---|---|---|
| | surface layer | | |
| | (parts by atom) | Capacitance | MTTF |
| Comparative Example 1 | 0 | 1 (reference) | 1 (reference) |
| Example 1 | 0.05 | 1.01 | 1.69 |
| Example 2 | 0.1 | 1.01 | 1.85 |
| Example 3 | 0.5 | 1.02 | 1.98 |
| Example 4 | 1.0 | 1.0 | 2.55 |
| Example 5 | 2.5 | 1.0 | 2.67 |
| Example 6 | 4.0 | 1.0 | 2.71 |
| Example 7 | 5.0 | 1.0 | 2.85 |
| Comparative Example 2 | 5.5 | 0.74 | 1.55 |
| Comparative Example 3 | 6.0 | 0.71 | 1.03 |

Referring to Table 2, the multilayer ceramic capacitors according to Examples 1 to 7 exhibited excellent capacitance characteristics and simultaneously, excellent high-temperature reliability, compared with the multilayer ceramic capacitors according to Comparative Examples 1 to 3. Accordingly, the multilayer ceramic capacitor according to an embodiment had an internal electrode layer in which a surface layer including bismuth (Bi) was disposed on the surface of a metal layer, wherein as the bismuth (Bi) had a predetermined content range, nickel oxidation in the internal electrode layer was suppressed, resulting in excellent high-temperature reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the internal electrode layer comprises:
a metal layer including nickel (Ni); and
a surface layer disposed on a surface of the metal layer and including bismuth (Bi), and
bismuth (Bi) is included in the surface layer in an amount of 0.01 parts by atom to 5.3 parts by atom based on 100 parts by atom of nickel (Ni) present in the entire internal electrode layer.

2. The multilayer ceramic capacitor of claim 1, wherein
bismuth (Bi) is included in the surface layer in an amount of 0.05 parts by atom to 5.0 parts by atom based on 100 parts by atom of nickel (Ni) present in the entire internal electrode layer.

3. The multilayer ceramic capacitor of claim 1, wherein
the surface layer is disposed at an interface between the metal layer and the dielectric layer on the surface of the metal layer.

4. The multilayer ceramic capacitor of claim 3, wherein
the interface is disposed on an upper surface of the metal layer, a lower surface of the metal layer, and a side surface of the metal layer in a thickness direction of the multilayer ceramic capacitor, and
the surface layer is disposed on at least one of the upper surface of the metal layer, the lower surface of the metal layer, and the side surface of the metal layer.

5. The multilayer ceramic capacitor of claim 3, wherein
the surface layer is disposed between an end of the metal layer electrically connected to the external electrode and one side of the external electrode.

6. The multilayer ceramic capacitor of claim 3, wherein
the surface layer surrounds an entire surface of the metal layer.

7. The multilayer ceramic capacitor of claim 1, wherein
when analyzing a TEM-EDS (Transmission Electron Microscopy-Energy Dispersive Spectroscopy) line for a straight section from one point in the internal electrode layer to one point in the dielectric layer adjacent to the internal electrode layer,
the metal layer is a region having a maximum atomic % value of nickel (Ni), and
the surface layer is a region having a maximum atomic % value of bismuth (Bi).

8. The multilayer ceramic capacitor of claim 1, wherein
the surface layer further comprises bismuth oxide (Bi₂O₃).

9. The multilayer ceramic capacitor of claim 1, wherein
the surface layer further comprises nickel (Ni).

10. The multilayer ceramic capacitor of claim 9, wherein
bismuth (Bi) is included in the surface layer in an amount of greater than or equal to 50 atomic % based on a total amount of bismuth (Bi) and nickel (Ni) present in the surface layer.

11. The multilayer ceramic capacitor of claim 9, wherein
bismuth (Bi) is included in the surface layer in an amount of 50 atomic % to 75 atomic % based on a total amount of bismuth (Bi) and nickel (Ni) present in the surface layer.

12. The multilayer ceramic capacitor of claim 9, wherein
the surface layer further comprises at least one selected from titanium (Ti), barium (Ba), and oxygen (O).

13. The multilayer ceramic capacitor of claim 1, wherein
the surface layer has an average thickness of 1 nm to 50 nm.

14. The multilayer ceramic capacitor of claim 3, wherein
the surface layer surrounds an entirety of the metal layer.

15. The multilayer ceramic capacitor of claim 9, wherein
the surface layer further comprises titanium (Ti), barium (Ba), and oxygen (O).

16. A method of manufacturing a multilayer ceramic capacitor, comprising
mixing nickel (Ni) and a bismuth (Bi)-based raw material to prepare a conductive paste;
manufacturing a dielectric green sheet from a dielectric slurry and printing the conductive paste on a surface of the dielectric green sheet to form a conductive paste layer;
manufacturing a dielectric green sheet stack by stacking a plurality of the dielectric green sheets on which the conductive paste layer is formed;
manufacturing a capacitor body comprising a dielectric layer and an internal electrode layer by firing the dielectric green sheet stack; and
forming an external electrode on an outer surface of the capacitor body,
wherein the internal electrode layer comprises a metal layer including nickel (Ni); and a surface layer disposed on a surface of the metal layer and including bismuth (Bi), and
the bismuth (Bi)-based raw material is mixed in an amount such that bismuth (Bi) is present in 0.01 parts by atom to 5.3 parts by atom based on 100 parts by atom of nickel (Ni) present in the entire internal electrode layer.

17. The method of claim 16, wherein
the bismuth (Bi)-based raw material comprises at least one selected from bismuth (Bi) and bismuth oxide (Bi₂O₃).

18. The method of claim 17, wherein
the bismuth (Bi)-based raw material comprises bismuth oxide (Bi₂O₃).
